(19) United States
(12) Patent Application Publication
(10) Pub. No.: US 2025/0242275 A1
(43) Pub. Date: Jul. 31, 2025

(54) APPARATUS AND METHOD FOR PROCESSING A BIOMASS MATERIAL

(71) Applicants: BUSS-SMS-CANZLER GMBH, Butzbach (DE); Nederman LCI Corporation, Charlotte, NC (US)

(72) Inventors: Rainer NAEF, Dietikon (CH); Matthias MONTGOMERY, Charlotte, NC (US); Remington FISCHER, Charlotte, NC (US); Austin BOSEMER, Charlotte, NC (US)

(73) Assignees: BUSS-SMS-CANZLER GMBH, Butzbach (DE); Nederman LCI Corporation, Charlotte, NC (US)

(21) Appl. No.: 18/426,698

(22) Filed: Jan. 30, 2024

(51) Int. Cl. B01D 1/22; B01D 1/06; B01D 1/28

(52) U.S. Cl. CPC B01D 1/225; B01D 1/06; B01D 1/228; B01D 1/2896

(57) ABSTRACT

An apparatus for processing a biomass material includes an evaporator and a dryer. The evaporator includes a vertically orientated evaporator housing with a heatable casing, which encloses a rotationally symmetric evaporation chamber and a drivable evaporator rotor shaft, including a central evaporator rotor shaft body and wiping units. The wiping unit includes wiping elements designed for wiping inside the evaporator housing casing. The dryer includes a housing with heatable casing and encloses a drying chamber and a drivable dryer rotor shaft for distributing the biomass material inside the casing and conveying the biomass material toward the dryer outlet and includes a central dryer rotor shaft body and rotating elements over the circumference thereof, and rigidly mounted on the dryer rotor shaft body.

### FIELD OF THE INVENTION

The present invention relates to an apparatus for processing a biomass material, according to the preamble of claim 1, as well as to a method for processing a biomass material using the apparatus, according to the preamble of claim 11.

### BACKGROUND OF THE INVENTION

Biofuels and bioproducts derived from sustainable feedstocks have emerged as promising solutions for addressing the challenges associated with human population growth. In particular, these bio-based alternatives have the potential of reducing dependence on fossil fuels, mitigating climate change, promoting rural development, and fostering a circular economy.

Aiming at unlocking the full potential of bioproducts and ensure their long-term viability, the processing of biomass is therefore under intensive investigation and development. Current challenges to the realization of an affordable and scalable biomass conversion technology are those associated with complicated process designs, difficulties associated with efficient solvent recycle, and water consumption.

In consideration of these challenges, WO 2021/168154 suggests a method to produce a sugar from a biomass, the method comprising: (a) providing a first mixture comprising a solubilized biomass and a distillable acid-base conjugate (DABCS) or deep eutectic solvent (DES); and (b) distilling at least part of the DABCS from the first mixture in order to separate the at least part of the DABCS from the first mixture. According to the method of WO 2021/168154, the DABCS is a protic ionic liquid (PIL) or a protic salt comprising a DABCS cation and a DABCS anion, and the DES is any combination of Lewis or Bronsted acid and base comprising any anionic and/or cationic species that have sufficient vapor pressure so that it can be readily distilled. The method of WO 2021/168154 further comprises the optional steps of introducing an enzyme and/or a microbe to the first mixture such that the enzyme and/or microbe produce a sugar from the solubilized biomass; and separating the sugar from the first mixture.

In order to be suitable for a large-scale application, it is necessary that the method allows the processing medium to be recovered at high recovery rates to obtain a high purity of the processed biomass and to keep the amount of processing medium required to a minimum. This is particularly important, since the compounds used in the processing medium are typically expensive.

In referring to the technology disclosed in WO 2021/168154, WO 2023/084131 suggests a method for processing a biomass material, wherein the method comprises the steps of feeding a mixture comprising the biomass material and a (pre-) treatment medium comprising a nitrogen compound into a vessel of an apparatus, which comprises means to heat an internal surface of the vessel and a plurality of blades arranged to rotate within the vessel. By treating the mixture with the plurality of blades, it is according to WO 2023/084131 exposed to shearing, and forced to form a continuously renewed evaporation surface between the mixture and a gaseous phase, thus allowing the nitrogen compound to form a gaseous form and allowing the gaseous form to pass through the evaporation surface and move into the gaseous phase.

According to WO 2023/084131, known apparatuses used for example in polymer processing technology, e.g. for devolatilizing of plastic fossil polymers, can be used for the method disclosed therein. For example, WO 2023/084131 mentions Filmtruder or Viscon processors (Buss-SMS-Canzler GmbH, Butzbach, Germany) or Viscofilm® processors (GIG Karasek GmbH, Gloggnitz-Stuppach, Austria) as suitable thin-film processors, and ReaCom and ReaSil processors (Buss-SMS-Canzler GmbH) or “Large Volume Devolatilization Kneaders” (LIST Technology AG, Arisdorf, Switzerland) as suitable large-volume processors.

However, WO 2023/084131 does not indicate any specification of the apparatus that would enable the skilled person to process an inhomogeneous biomass, in particular a biomass with relatively large grain sizes or a large grain size distribution of the solids contained therein. Accordingly, the biomass processed in WO 2023/084131 has a small particle size of 2 mm, which requires the initial feedstock to be subjected to an upstream milling process prior to it being fed into the vessel of the apparatus. In addition, WO 2023/084131 does not address the problems typically seen in the processing of biomass material during the start-up and shutdown phase, which are due to the occurrence of material compaction, partially dried areas and, hence, the formation of solid particles, which may ultimately lead to jamming of the apparatus.

Thus, the method of WO 2023/084131 cannot be implemented economically on a large industrial scale.

### SUMMARY OF THE INVENTION

In consideration of the drawbacks of the prior art, in particular the method of WO 2023/084131, the object of the present invention is therefore to provide an apparatus and a method for the processing of a biomass material, which allows for a safe, economic and flexible operation also in case that a biomass of high inhomogeneity is subjected to the processing and which further allows to achieve high recovery rates of the processing medium used or components thereof. In particular, the apparatus and the method shall allow the processing to be scaled up to large capacities, e.g. in a biorefinery.

This object is solved by the apparatus of claim 1 and the method of claim 11, respectively. Preferred embodiments of the apparatus and the method are defined in the dependent claims.

Thus, the invention relates according to claim 1 to an apparatus for processing a biomass material, which is provided in the form of a mixture comprising a biomass and a processing medium containing or consisting of a distillable nitrogen compound, the apparatus comprising
a) an evaporator comprising
   a vertically orientated evaporator housing having a heatable evaporator housing casing, which encloses a rotationally symmetric evaporation chamber extending in the axial direction A,
   an evaporator inlet port, which is arranged in an inlet region of the evaporator housing, for feeding the biomass material to be processed into the evaporation chamber,
   an evaporator outlet port, which is arranged in an outlet region of the evaporator housing, for discharging the material from the evaporation chamber, and
   a coaxially extending, drivable evaporator rotor shaft, arranged in the evaporation chamber, for producing a biomass material film on the internal surface of the evaporator housing casing, the evaporator rotor shaft comprising a central evaporator rotor shaft body and a plurality of wiping units distributed over the circumference thereof, each wiping unit comprising a plurality of outwardly extending wiping elements arranged successively in axial direction and designed for wiping over the internal surface of the evaporator housing casing, the wiping elements of a wiping unit being hinged in a manner such that they are deflectable in relation to the rotation direction of the evaporator rotor shaft.

According to claim 1, the apparatus further comprises
b) a dryer comprising
   a horizontally oriented dryer housing having a heatable dryer housing casing, which encloses a rotationally symmetric drying chamber extending in the axial direction A′,
   a dryer inlet port, which is arranged in an inlet region of the dryer housing and is fluidly connected with the evaporator outlet port, for feeding the biomass material discharged from the evaporation chamber into the drying chamber, and
   a dryer outlet port, arranged in an outlet region of the dryer housing, for discharging the material from the drying chamber, and
   a coaxially extending, drivable dryer rotor shaft, arranged in the drying chamber, for distributing the biomass material on the internal surface of the dryer housing casing and for conveying the biomass material in the direction away from the dryer inlet region toward the dryer outlet region and comprising a central dryer rotor shaft body and a plurality of rotating elements distributed over the circumference thereof, said rotating elements being rigidly mounted on the dryer rotor shaft body.

By using a (wiped-film) evaporator as defined in claim 1, an increased heat transfer performance can be achieved in the first stage of the processing, thus allowing for a very efficient evaporation of the processing medium. Since the evaporator housing is oriented vertically, transport of the biomass material is supported by downwards flowing owed to gravitation, thus allowing to keep the energy required for conveying the material in the first stage to be kept minimally.

Due to the wiping elements of each wiping unit being hinged, the present invention allows the biomass to be safely processed. In the event that a wiping element encounters a relatively large particle present in the biomass material, it is pivotably deflected backwards when viewed in the direction of rotation. Thus, the risk of jamming or excessive energy input in the evaporation chamber is mitigated, which is of particular relevance for the start-up and shutdown of the processing, as mentioned above. Typically, the wiping elements are designed in such a way that, once the deflecting particle has been passed over, they return to their original position due to the centrifugal force acting on them during rotation. In particular, this can be achieved by the wiping elements being relatively heavy.

As will be discussed in further detail below, it is preferred that the biomass material further comprises water besides the biomass and the processing medium.

For removing the evaporated distillable nitrogen compound from the evaporation chamber, the evaporator further comprises a gas outlet which leads to collecting tank, from where the vapour containing the nitrogen compound can be guided to module for condensing and/or reconditioning the vapour. This gas outlet can for example be arranged at an upper portion of the vertical evaporation housing. Although the vapour, in its path from evaporating from the material film and flowing in the direction to the gas outlet, can entrain liquid droplets or solid particles, these are thrown back again to the material film due to the centrifugal force exerted by wiping and the rotating elements, hence efficiently removed from the vapour stream. Thus, the wiping elements, in addition to their function of distributing the material on the internal surface of the evaporator, further fulfil the function of a material separator and in this respect further contribute to the high recovery rate of the distillable nitrogen compound achievable according to the present invention.

The evaporator used in the apparatus of the present invention is therefore different to the thin-film processors disclosed in WO 2023/084131 A2 and—in comparison to the technology of WO 2023/084131 A2—allows for a safe operation even if a biomass of a relatively high inhomogeneity is processed, as it is typically the case in large scale applications, e.g. a biorefinery. An evaporator comprising hinged wiping elements is not disclosed in US2017197994A1 either, which relates to a method of recovery of ionic liquid, but not in the context of processing biomass material.

Owed to the combination with a dryer used for the second stage, there is no need to “force” the biomass material in the first stage to a state of concentration where unwanted precipitation may occur. Thus, the apparatus of the present invention allows to mitigate the risk of a more difficult conveying behavior to occur and of solid deposits to be formed on the inner surface of the evaporator.

In the dryer of the second stage, the processing medium is evaporated further, during which further evaporation the can pass through a slightly viscous biomass material transition stage, after which precipitation may occur. Due to the design of the dryer, the processed biomass can be safely conveyed to the dryer outlet opening. As will be discussed in more detail below, it is thereby preferred that the biomass material contains at least some water, in particular in view of a better transportability of the material and of further degradation processes of the biomass material downstream of the apparatus requiring water. The presence of water is also important in view of a restart of the system after an unforeseen shut-down or process upset conditions where the material can get tougher and eventually form solids which are more difficult to process.

Overall, the apparatus of the present invention is thus less prone to a potential overloading.

Hence, the apparatus and the method of the present invention allow for an economic, safe and flexible processing of the biomass material, which can be scaled up and in particular of can satisfy the requirements the capacity a of biorefinery. Owed to a very efficient heat transfer achievable in the first stage, an optimized recovery rate of the processing medium, in particular the nitrogen compound, can be achieved.

In the second stage, also water contained in the biomass material might be removed by evaporation due to the similar vapour pressure as the processing medium. As the presence of some water in the drying chamber is preferred in view of the transportability of the material and of further (downstream) degradation processes, the process preferably contains the further steps of recovering removed water and re-introducing it into the drying chamber. Ultimately, this allows water consumption to be limited, which is of particular relevance for scaling up the processing to large capacities of e.g. a biorefinery.

According to a preferred embodiment, the dryer is a thin-film dryer, in which at least a part of the rotating elements is in the form of a distributing element, the radial outer part of which being formed by a distributing blade. Specifically, the distributing elements of this embodiment are in the form of teeth protruding radially from the dryer rotor shaft body. As will be discussed in the context of the drawings, the distributing blade of the distributing element can run in a direction essentially parallel to the rotor shaft axis, in which case the distributing blade has exclusively a distributing function, meaning that it solely serves to distribute a material film on the internal surface of the housing casing. Alternatively, the edge of the distributing blade can be tilted with regard to the axial direction A′, in which case the respective distributing blade also has a conveying function in addition to the distributing function, meaning that it forces the material in the direction towards the dryer outlet port. In this case, the angle between the direction of the distributing blade also functioning as a conveying element and the axial direction A′ is in the range of from 5° to 45°, preferably from 10° to 25°.

In an alternative embodiment different to the thin-film dryer discussed above, at least a part of the rotating elements of the dryer can be in the form of a segmental disc and/or a segmental scraper comprising a peripheral end running parallel to the inner surface of the dryer, the leading edge of the peripheral end being beveled. A respective design of the dryer rotor shaft according to this embodiment will also be discussed in further detail in the context of the drawings. In particular for this embodiment, it is further preferred that least a part of the rotating elements form, at least in their peripheral region facing the inner surface of the dryer housing casing, an angle of inclination in relation to the axial direction A′, more preferably in a range of from 1° to 25°, most preferably of from 2° to 10°.

Typically, the apparatus comprises a vapour vent for removing vapour generated during processing from the evaporation chamber and the drying chamber, respectively. Preferably, the evaporator and the dryer share one common vapour vent. Typically, this vapour vent is arranged in the upper portion of the evaporator housing.

According to a particularly preferred embodiment, the vapour vent can be fluidly connected to a column for condensing water contained in the vapour and a channel for re-introducing at least a part of the condensed water back to the drying chamber. This allows good transportability of the material to be maintained in the drying chamber without requiring additional water to be supplied from an external source.

As mentioned above, the wiping elements are according to the present invention hinged in a manner such that they are deflectable in relation to the rotation direction of the evaporator rotor shaft, hence allowing biomass material of relatively high inhomogeneity to be safely processed. Specifically, the wiping elements of a wiping unit are hingedly connected to a support, in particular a spindle, mounted to the evaporator rotor shaft. More specifically, the spindle can be mounted between two radial outer rings connected to the evaporator rotor shaft body and arranged coaxially thereto.

According to a further preferred embodiment, the dryer rotor shaft comprises at least one lift element arranged on the dryer rotor shaft body, which lift element is designed in such a way as to produce a lifting force in the direction of the rotor shaft body during the rotation of the rotor shaft. These lift elements allow a deflection of the rotor shaft caused by the force of gravity to be effectively counteracted. Thus, safe operation can be ensured even for a dryer with a relatively long rotor shaft. The effect obtained is particularly pronounced for a thin-film treatment apparatus in which the dryer housing interior extends over a length of at least 5 m, preferably at least 8 m.

With regard to the embodiment containing a dryer rotor shaft comprising at least one lift element, it is further preferred that the lift element has a planar incident-flow portion with a leading end in the rotation direction, which leading end is arranged at a greater distance from the inner surface of the dryer housing casing than a region of the incident-flow portion trailing behind the leading end. A gap that narrows in a direction counter to the rotation direction is thus formed between the incident-flow portion and the inner surface of the dryer housing casing. In accordance with a particularly preferred embodiment, the incident-flow portion extends in a plane oriented at an incline to the tangent or tangential plane of the inner surface of the dryer housing casing, whereby a gap narrows continuously in a that direction counter to the rotation direction is formed between the incident-flow portion and the inner surface of the dryer housing casing. It is furthermore preferred that the angle between the tangent or tangential plane of the inner surface of the housing casing and the incident-flow portion lies in the range of from 15° to 30°, in particular at approximately 20°. Here, a “tangent” of the inner surface of the dryer housing casing is understood to mean the tangent that touches the inner surface of the dryer housing casing, which is circular in section, at the point that lies closest to the radially outermost end of the incident-flow portion. The gap formed between the inner surface of the housing casing and the incident-flow portion preferably narrows by a factor of more than 10.

As the dryer rotor shaft rotates the biomass material to be processed, which generally has a viscosity above a certain viscosity threshold, it is pressed into the gap, whereby the flow force of the rotor shaft acting on the incident-flow portion provides a hydrodynamic lift component perpendicularly to the incident-flow direction. This lift component is relatively high especially in the case of a relatively highly viscous material. A deflection of the dryer rotor shaft is thus effectively counteracted, wherein the effect is particularly pronounced when processing material having a viscosity above a certain threshold.

In order to ensure that a hydrodynamic lift component is obtained already at the time of start-up, it can be preferred, at least in the start-up phase, to introduce a partial flow of the material to be treated in a region of the dryer in which lift elements are present. For this purpose, the dryer, in addition to the inlet port in the inlet zone, can thus have a further inlet port which is arranged downstream of the inlet zone. The proportion of this partial flow in the total amount of material introduced into the apparatus is selected here in such a way that, on the one hand, a sufficiently high lift component is obtained, and, on the other hand, the residence time of the material in the dryer is still long enough to ensure the desired processing.

In accordance with a particularly preferred embodiment at least a part of the lift elements is formed in each case by a distributing element. This distributing element thus performs the dual function, besides the function as a lift element, of also distributing the biomass material to be processed and, optionally, of imparting to the material a conveying component in the direction of the material outlet. In case the lift element also performs a conveying function, the conveying angle, i.e. the angle enclosed by a conveying edge of the lift element and the axis, is preferably in a range of 2 to 5°.

According to a specific embodiment, which will also be discussed in the context of the drawings, the lift element comprises an at least approximately pitched-roof-shaped web plate, the ridge of which runs at least approximately parallel to the axis direction of the dryer rotor shaft. Due to the angled form, the web plate is thus divided into a first and second web plate surface, which lie in planes running obliquely relative to one another.

In addition to the apparatus defined above, the present invention relates according to a further aspect to a method for processing a biomass material using the apparatus, the biomass material being provided in the form of a mixture comprising a biomass and a processing medium containing or consisting of a distillable nitrogen compound.

The method comprises the subsequent steps of:
i) feeding the biomass material into the evaporator for pre-concentrating the biomass material by partially evaporating the processing medium, and
ii) transferring the biomass material pre-concentrated in step i) into the dryer for further evaporating residual processing medium.

The method allows to efficiently remove the nitrogen compound, preferably the complete medium, from the mixture comprising the biomass material. In more concrete terms, the method allows removal of more than 99.8% of the nitrogen compound, which is important in view of the process economy and the further processing steps using bacteria, for which the nitrogen compound can be harmful and the efficiency of which would be negatively affected by the nitrogen compound. By using the apparatus described above combining an evaporator with a dryer, the processing of the material is optimized in that the processing is adapted to the changing rheological properties during evaporation. For the first stage, an evaporator is used allowing a high heat transfer performance to be achieved, whereas for the second stage, a dryer is used allowing higher shear forces to be introduced and hence a repeated renewal of the surface also at a stage in which the material has reached a relatively high viscosity. Thus, a very efficient evaporation of the processing medium, and ultimately a high recovery rate, can be achieved by the method of the invention.

According to a particularly preferred embodiment, the further steps of collecting and condensing the evaporated processing medium. Hence, the processing medium can, after a possibly necessary reconditioning, be recycled. In this regard, it is in particular conceivable to use the processing medium for admixing it to new biomass prior to it being introduced into the apparatus of the invention.

As mentioned above, the biomass material fed into the evaporator in step i) may further comprise water apart from the processing medium, to ensure good transportability. This may in particular be an issue in the dryer, where evaporation of distillable components of the biomass material (and, hence, its “drying”) has reached an advanced stage. As also discussed above, it may thus be advantageous to at least partially re-introduce water removed by evaporation in step i) and/or step ii) into the drying chamber.

The term “processing medium” as used in the context of the present invention is to be interpreted broadly and covers media to be used for the pre-processing of biomass, such as deconstructing the (cellular) structure of the biomass before applying subsequent processing steps such as, for example, enzymatic/microbial hydrolyzation or fermentation.

As mentioned, the processing medium used for the biomass material to be processed in the apparatus and the method of the present invention contains or consists of a distillable nitrogen compound.

According to a preferred embodiment, the processing medium contains a nitrogen-containing distillable acid-base conjugate salt (DABCS) or deep eutectic solvent (DES), in which
the DABCS is a protic ionic liquid (PIL) or a protic salt comprising a DABCS cation and a DABCS anion, and
the DES is any combination of Lewis or Bronsted acid and base comprising any anionic and/or cationic species that have sufficient vapor pressure so that it can be readily distilled.

For a detailed definition of the DABCS and the DES it is referred to WO 2021/168154.

Specifically, the DABCS is a protic liquid. Suitable protic ionic liquids (PILs) include fused salts with a melting point less than 100° C. with salts that have higher melting points referred to as molten salts. Suitable PILs are disclosed in Ionic Greaves et al. “Protic Liquids: Properties and Applications” Chem. Rev. 108 (1): 206-237 (2008). PILs can be prepared by the neutralization reaction of certain Bronsted acids and Bronsted bases (generally from primary, secondary or tertiary amines, which are alkaline) and the fundamental feature of these kinds of ionic liquids is that their cations have at least one available proton to form hydrogen bond with anions. In some embodiments, the protic ionic liquids (PILs) are formed from the combination of organic ammonium-based cations and organic carboxylic acid-based anions. PILs are acid-base conjugate ILs that can be synthesized via the direct addition of their acid and base precursors. In some embodiments, the PIL is a hydroxyalkylammonium carboxylate. In some embodiments, the hydroxyalkyl ammonium comprises a straight or branched C1, C2, C3, C4, C5, C6, C7, C8, C9, or C10 chain. In some embodiments, the carboxylate comprises a straight or branched C1, C2, C3, C4, C5, C6, C7, C8, C9, or C10 chain. In some embodiments, the carboxylate is substituted with one or more hydroxyl groups. In some embodiments, the PIL is a hydroxy ethyl ammonium acetate.

According to a specific embodiment, the protic ionic liquid (PIL) is disclosed by U.S. Patent Application Publication No. 2004/0097755, hereby incorporated by reference.

As mentioned, DES are systems formed from a eutectic mixture of Lewis or Bronsted acids and bases which can contain a variety of anionic and/or cationic species. DESs can form an eutectic point in a two-component phase system. DESs are formed by interaction of quaternary ammonium salts (such as, choline chloride) with hydrogen bond donors (HBD) such as amines, amides, alcohols, or carboxylic acids. The interaction of the HBD with the quaternary salt reduces the anion-cation electrostatic force, thus decreasing the melting point of the mixture. DESs share many features of conventional ionic liquid (IL), and promising applications would be in biomass processing, electrochemistry, and the like. In some embodiments, the DES is any combination of Lewis or Bronsted acid and base. In some embodiments, the Lewis or Bronsted acid and base combination used is distillable.

In some embodiments, DES is prepared using an alcohol (such as glycerol or ethylene glycol), amines (such as butylamine), and an acid (such as oxalic acid or lactic acid). The present invention can use renewable DESs with lignin-derived phenols as HBDs. Both phenolic monomers and phenol mixture readily form DES upon heating at 100° C. with specific molar ratio with choline chloride. This class of DES does not require a multistep synthesis. The DES is synthesized from lignin which is a renewable source.

Both monomeric phenols and phenol mixture can be used to prepare DES. DES is capable of dissolving biomass or lignin, and can be utilized in biomass pretreatment and other applications. Using DES produced from biomass could lower the cost of biomass processing and enable greener routes for a variety of industrially relevant processes.

The DES, or mixture thereof, is bio-compatible: meaning the DES, or mixture thereof, does not reduce or does not significantly reduce the enzymatic activity of the enzyme used for processing the biomass, and/or is not toxic, and/or does not reduce or significantly reduce, the growth of the microbe. A “significant” reduction is a reduction to 70, 80, 90, or 95% or less of the enzyme's enzymatic activity and/or the microbe's growth (or doubling time), if the DES, or mixture thereof, was not present.

According to a specific embodiment, the DES, or mixture thereof, comprises a quaternary ammonium salt and/or glycerol. More specifically, the DES, or mixture thereof, can comprise a quaternary ammonium salt and/or glycerol. In some embodiments, the quaternary ammonium salt and/or glycerol have a molar ratio of about 1:1 to about 1:3. In some embodiments, the quaternary ammonium salt and/or glycerol have a molar ratio of about 1:1.5 to about 1:2.5. In some embodiments, the quaternary ammonium salt and/or glycerol have a molar ratio of about 1:1.8 or 1:1.9 to about 1:2.1 or 1:2.2. In some embodiments, the quaternary ammonium salt and/or glycerol have a molar ratio of about 1:2. In some embodiments, the quaternary ammonium salt is a choline halide, such as choline chloride.

According to a further preferred embodiment, the nitrogen compound is a nitrogen compound as disclosed in WO 2023/084131.

Specifically, the nitrogen compound is selected from the group consisting of NH3, methylamine, ethylamine, propylamine, isopropylamine, butylamine, hexylamine, octylamine, dimethylamine, diethylamine, dipropylamine, dibutylamine, trimethylamine, triethylamine, tripropylamine, tributylamine, dimethylethylamine, dimethylpropylamine, dimethylbutylamine, cyclohexylamine, ethanolamine, N-3-amino-1-methylethanolamine, N, N-dimethylethanolamine, 4-amino-1-butanol, propanol, 3-amino-2-propanol, ethylenediamine, 1,3-diaminopropane, 1,4-diaminobutane, 1,3-diamino-2-propanol, 1,1,3,3-tetramethylguanidine, pyridine, pyrrole, morpholine, N-methylmorpholine, N-ethylmorpholine, piperidine, N-methylpiperidine, N-ethylpiperidine, imidazole, N-methylimidazole, N-ethylimidazole, pyrrolidine, N-methylpyrrolidine, N-ethylpyrrolidine, N-butylpyrrolidine, N-methylethylenediamine, and N,N,N′,N′-tetramethylethylenediamine.

As mentioned above, it is further preferred that the nitrogen compound is selected from the group of ionic liquids, in particular nitrogen-based protic ionic liquids. The class of nitrogen-based protic ionic liquids meets the criteria of a nitrogen compounds as defined above as the cation of these ionic liquids represents a protonated (organic) nitrogen compound.

In a preferred embodiment, the ionic liquid has a pseudo boiling point (Tb) of about 210° C. or below, preferably about 200° C. or below, at normal pressure (i.e., about 1,000 mbar or about 1 atm). An ionic liquid having a pseudo boiling point (Tb) of at most about 210° C. at normal pressure is preferred, as it is distillable under preferred conditions (temperature, pressure) of the method according to the invention.

The pseudo boiling point of an ionic liquid defines a temperature at a given pressure, e.g., normal pressure, at which minimum temperature the ionic liquid is transferred from liquid into a gaseous form, or at which maximum temperature the ionic liquid can be recovered from gaseous form in the liquid form.

The pseudo boiling point Tb of a compound can be detected for example by means of thermogravimetric analysis (TGA) at a typical heating rate of e.g. 5 K/min as an onset-temperature of mass loss and as a strong endothermic signal in a differential scanning calorimetry (DSC) experiment under analogue conditions, as known to a person skilled in the art.

For an acid base conjugate salt ionic liquid, the gaseous form preferably consists of the evaporable neutral base and the evaporable neutral acid. Thus, a distillable ionic liquid is at least partially transferred into their neutral precursors to form the gaseous form.

More preferably, the acid is selected from the group consisting of formic acid, acetic acid, propionic acid, butyric acid, valeric acid, caproic acid, acrylic acid, glycolic acid, lactic acid, phenol, and salicylic acid.

Accordingly, the neutral nitrogen compound forming the cation is preferably selected from the group consisting of trimethylamine, tri ethylamine, tripropylamine, tributylamine, dimethylethylamine, dimethylpropylamine, dimethylbutylamine, N, N-dimethylethanolamine, pyridine, N-methylmorpholine, N-ethylmorpholine, N-methylpiperidine, N-ethylpiperidine, N-methylimidazole, N-ethylimidazole, N-methylpyrrolidine, N-ethylpyrrolidine, N-butylpyrrolidine, and N,N,N′,N′-tetramethylethylenediamine. In a preferred embodiment, the acid base conjugate ionic liquid is selected from the group of butylammonium formate, dibutylammonium formate, diethylammonium formate, dimethylammonium formate, dipropylammonium formate, ethanolammonium formate, ethylammonium formate, methylammonium formate, morpholinium formate, N-ethylmorpholinium formate, N-ethylimidazolium formate, N-methylimidazolium formate, N-methylmorpholinium formate, propylammonium formate, N-methylpyrrolidinium formate, pyridinium formate, pyrrolidinium formate, tributylammonium formate, triethylammonium formate, trimethylammonium formate, tripropylammonium formate, a-picolinium formate, butylammonium acetate, dibutylammonium acetate, diethylammonium acetate, dimethylammonium acetate, dipropylammonium acetate, ethanolammonium acetate, ethylammonium acetate, methylammonium acetate, morpholinium acetate, N-ethylimidazolium acetate, N-ethylmorpholinium acetate, N-methylimidazolium acetate, N-methylmorpholinium acetate, N-methylpyrrolidinium acetate, propyl ammonium acetate, pyridinium acetate, pyrrolidinium acetate, tributylammonium acetate, triethylammonium acetate, trimethyl ammonium acetate, tripropyl ammonium acetate, a-picolinium acetate, butylammonium propionate, dibutylammonium propionate, diethylammonium propionate, dimethylammonium propionate, dipropylammonium propionate, ethanolammonium propionate, ethylammonium propionate, methylammonium propionate, morpholinium propionate, N-ethylimidazolium propionate, N-ethylmorpholinium propionate, N-methylimidazolium propionate, N-methylmorpholinium propionate, N-methylpyrrolidinium propionate, propylammonium propionate, pyridinium propionate, pyrrolidinium propionate, tributylammonium propionate, triethylammonium propionate, trimethylammonium propionate, tripropylammonium propionate, a-picolinium propionate, butylammonium butyrate, dibutylammonium butyrate, diethylammonium butyrate, dimethylammonium butyrate, dipropylammonium butyrate, ethanolammonium butyrate, ethylammonium butyrate, methylammonium butyrate, morpholinium butyrate, N-ethylimidazolium butyrate, N-ethylmorpholinium butyrate, N-methylimidazolium butyrate, N-methylmorpholinium butyrate, N-methylpyrrolidinium butyrate, propylammonium butyrate, pyridinium butyrate, pyrrolidinium butyrate, tributylammonium butyrate, triethylammonium butyrate, trimethylammonium butyrate, tripropylammonium butyrate, a-picolinium butyrate, butylammonium lactate, dibutylammonium lactate, diethylammonium lactate, dimethylammonium lactate, dipropylammonium lactate, ethanolammonium lactate, ethylammonium lactate, methylammonium lactate, morpholinium lactate, N-ethylimidazolium lactate, N-ethylmorpholinium lactate, N-methylimidazolium lactate, N-methylmorpholinium lactate, N-methylpyrrolidinium lactate, propylammonium lactate, pyridinium lactate, pyrrolidinium lactate, tributylammonium lactate, triethylammonium lactate, trimethylammonium lactate, tripropylammonium lactate, and a-picolinium lactate.

In a further aspect, the nitrogen compound may be a hybrid form of neutral nitrogen compounds and ionic liquids. The term hybrid form is understood to include mixtures of a neutral nitrogen compound and an ionic liquid in any quantitative relation to each other. In one embodiment, the hybrid form comprises a neutral nitrogen compound and an ionic liquid, wherein the cation of the ionic liquid is derived from said neutral nitrogen compound. The term hybrid form also covers a nitrogen compound representing a mixture of an ionic liquid with a protonated nitrogen compound as cation with a different (i.e., unrelated) neutral nitrogen compound.

As discussed above, neutral nitrogen compounds and nitrogen-based protic ionic liquids, preferably ionic liquids being selected from acid base conjugate salts and alkyl carbamate ionic liquids, and hybrid forms thereof, all include compounds that readily vaporize under the pressure and temperature conditions preferred for the method according to the invention. Thus, they are especially suited for the method according to the present invention.

In a preferred embodiment, the medium has a content of the nitrogen compound in the range of from 10 to 100 wt. %, preferably from 50 to 100 wt. %, more preferably from 90 to 100 wt. % such as essentially 100 wt. %.

Whereas it may be preferred that the processing medium essentially consists of the nitrogen compound as defined above, in further embodiments, the processing medium comprises one or more further component(s). In an embodiment, further component(s) of the medium are selected from the group consisting of co-solvents, buffers, detergents, dispergents, anticorrosants, and antioxidants. Suitable co-solvents include for example water, alcohols (such as methanol, ethanol, 1-propanol, 2-propanol, 1-butanol, 2-butanol, and ethyleneglycole), ethers (such as ethyleneglycoldimethylether, ethyleneglycoldiethylether, ethyleneglycolmonoethylether, ethyleneglycolmonobutylether, dipropylether, di-n-butylether, di-iso-butylether, di-sec-butylether, di-tert-butylether, 2-methoxy-2-methylpropan), dihydrolevoglucosenone (Cyrene™), isosorbide-dimethylether, levoglucosenone, γ-valerolactone, carbonic acids (such as formic acid, acetic acid, propionic acid, and lactic acid), DMSO, 2,5-dimethylfuran, triethylphosphate, acetone and dissolved CO₂.

In one embodiment, the biomass material remaining collectable after the removal of the nitrogen compound is obtained in combination with a co-solvent, in particular the co-solvent from the medium. In this embodiment, the biomass is not retrieved as dry solid but kept in a moist or wet state by the co-solvent such as water or alcohol. This is desirable in situations, wherein the remaining biomass material should not dry out, for example a biomass material comprising intact cellular structures. Preferably, the remaining biomass material may be collected in combination with a co-solvent, in particular water, wherein the co-solvent, in particular water, is present in a concentration of from 5 to 30 wt. 8, preferably 10 to 25 wt. %, such as 20 wt. % with respect to said combination. Typically, the co-solvent, such as water or alcohol, forms a gaseous form, evaporates and is removed with the gaseous phase in the method according to the invention. However, supplementation of co-solvent during the processing allows to maintain a certain concentration of co-solvent, while the nitrogen compound is removed. Accordingly, in this embodiment, the method can further comprise adding a co-solvent, in particular continuously adding a co-solvent, preferably water, while removing the gaseous phase.

A neutral nitrogen compound as defined above may act as a co-solvent. Indeed, a neutral nitrogen compound may be advantageously added to an ionic liquid, which results in a hybrid form of the neutral nitrogen compound and the ionic liquid as described above.

Suitable buffers include for example ammonium carbonate, ammonium hydrogencarbonate, ammonium carbamate. Of note, neutral nitrogen compounds or ionic liquids themselves can act as buffer systems.

To allow for a good evaporation of the distillable nitrogen compound contained in the processing medium, the operating pressure both in the evaporator and in the dryer is preferably in the range of from 10⁻² mbar to 10³ mbar, preferably in the range of from 10 mbar to 500 mbar, more preferably in the range of from 50 to 250 mbar.

In view of an optimized evaporation, it is further preferred that both in the evaporator and in the dryer the internal surface of the evaporator housing casing and the dryer housing casing, respectively, is heated to a temperature in the range of from 20° C. to 200° C., more preferably of from 50° C. to 170° C., even more preferably of from 80° C. to 160° C., and most preferably from 100° C. to 140° C.

The apparatus and the method of the present invention allow biomass material of relatively high viscosity to be safely and efficiently processed. According to a specific embodiment, the biomass material to be processed has an initial shear viscosity of from 10 to 50,000 mPa*s, preferably in the range of from 100 to 20,000 mPa*s, more preferably about 500 to 15,000 mPa*s. In this regard, the viscosity values refer to the initial shear viscosity as determined using an oscillation rheometer with a two plates geometry at a shear rate of 10 s⁻¹ and a measuring temperature of about 100° C.

In addition, the apparatus and the method of the present invention allow a very high recovery rate of the processing medium, and in particular of the distillable nitrogen compound, to be achieved. Hence, the apparatus and the method are particularly well suited for a biomass material having a relatively high initial content of processing medium. According to a further preferred embodiment, the biomass material to be processed thus has an initial content of processing medium in the range of from 15 to 95 wt. % referring to the total amount of the biomass material, preferably from 20 to 90 wt. %, more preferably from 30 to 70 wt. %, most preferably from 40 to 50 wt. %.

According to a further preferred embodiment, the initial content of biomass in the biomass material to be processed is in the range from 5 to 30 wt. % referring to the total amount of the biomass material.

According to a still further preferred embodiment, the biomass material to be processed thus has an initial content of water in the range of from 0 to 50 wt. % referring to the total amount of the biomass material. If water is present in the biomass material to be processed, which relates to a preferred embodiment of the invention, the initial content of processing medium in the biomass material is preferably in the range of from 20 to 60 wt. % referring to the total amount of the biomass material, more preferably from 40 to 50 wt. %.

According to a specific embodiment, the biomass to be processed contains approximately 10 wt. % of biomass, approximately 45 wt. % of processing medium, in particular the distillable nitrogen compound, and approximately 45 wt. % of water.

### BRIEF DESCRIPTION OF THE DRAWINGS

The foregoing aspects and others will be readily appreciated by the skilled person from the following description of illustrative embodiments when read in conjunction with the accompanying figures, of which

FIG. 1 shows a perspective view of an embodiment of the apparatus according to the present invention comprising an evaporator and a dryer;

FIG. 2 shows a detailed perspective view of a portion of the evaporation chamber of an evaporator according to an embodiment of the present invention, in which an evaporator rotor shaft is arranged;

FIG. 3 shows a cross-section through the evaporator rotor shaft shown in FIG. 2;

FIG. 4 shows a perspective view of a dryer of a further embodiment of the apparatus according to the present invention, in which a section of the dryer housing casing is presented openly, thus showing the dryer rotor shaft arranged in the drying chamber of the dryer;

FIG. 5 shows a cross-section of an alternative dryer rotor shaft suitable for the apparatus of the present invention, and

FIG. 6 shows a perspective view of a section of a further dryer rotor shaft suitable for the apparatus of the present invention.

### DETAILED DESCRIPTION OF THE INVENTION

Before the invention is described in detail, it is to be understood that, unless otherwise indicated, the terminology used herein is for purposes of describing particular embodiments only, and is not intended to be limiting.

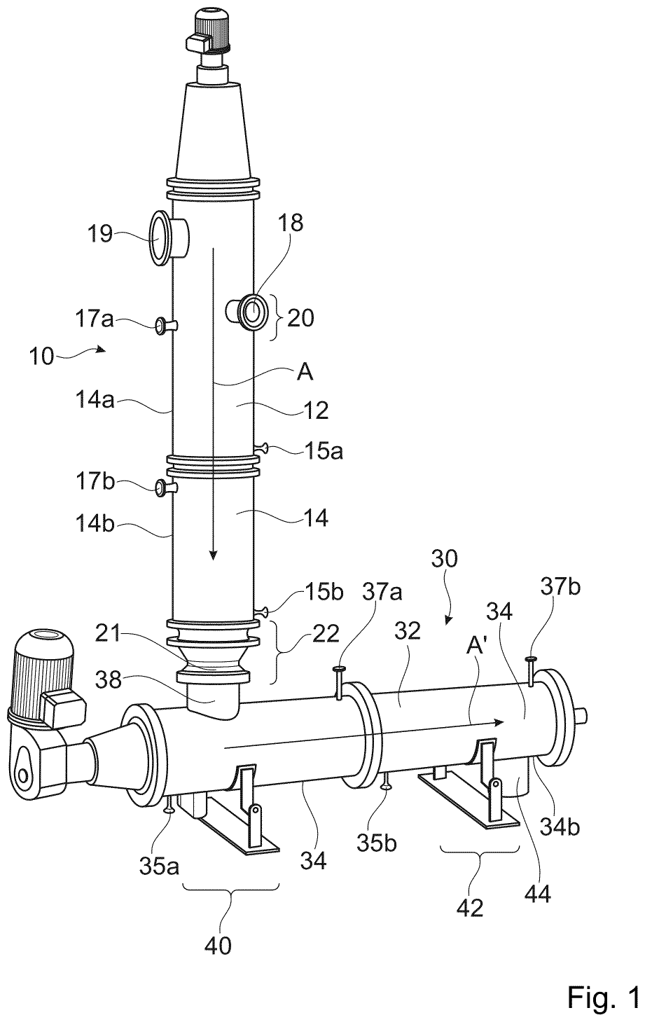

As shown in FIG. 1, the apparatus of the present invention comprises an evaporator (10) and a dryer (30) connected to the evaporator and arranged downstream in the processing direction.

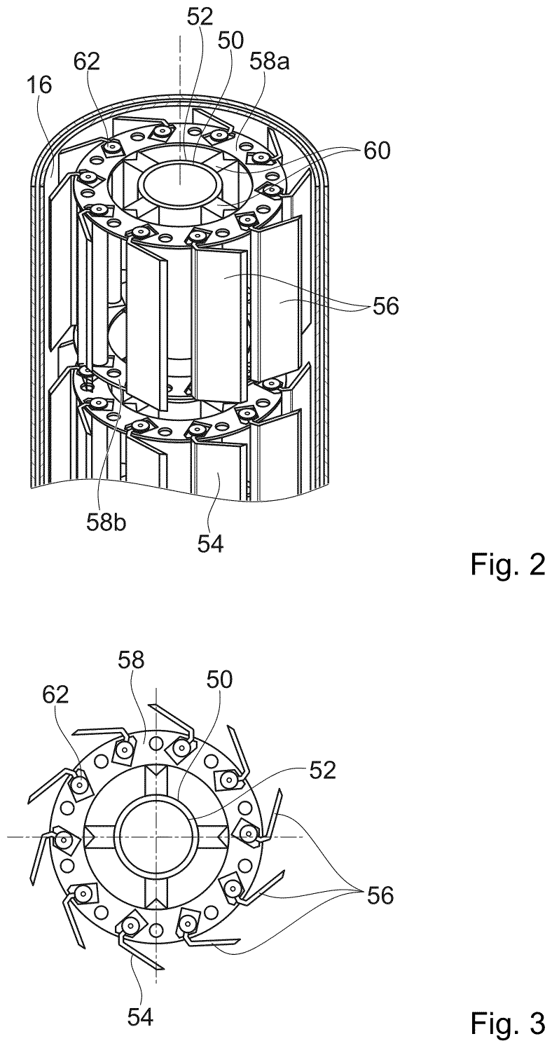

The evaporator comprises a vertically orientated evaporator housing (12) having a heatable evaporator housing casing (14), which encloses a rotationally symmetric evaporation chamber (16; shown in FIG. 2) extending in the axial direction A. The evaporator further comprises an evaporator inlet port (18), which is arranged in an inlet region (20) of the evaporator housing (12), for feeding the biomass material to be processed into the evaporation chamber (16), and an evaporator outlet port (21), which is arranged in an outlet region (22) of the evaporator housing (12), for discharging the material from the evaporation chamber (16). In the upper region of the evaporator, a vapour vent (19) is arranged.

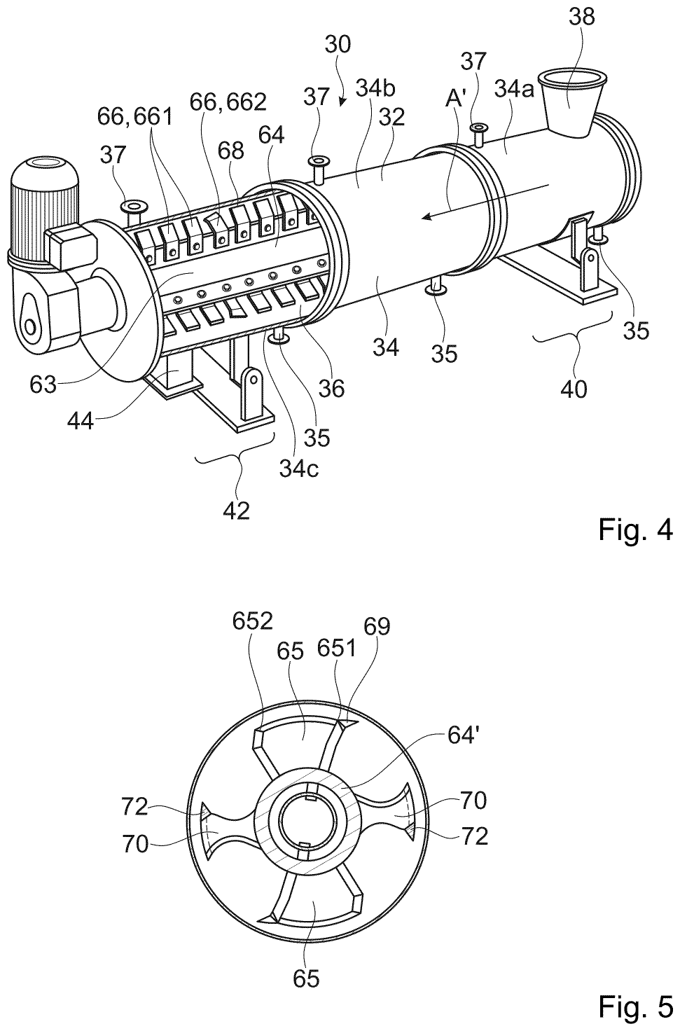

The dryer (30) of the apparatus comprises a horizontally oriented dryer housing (32) having a heatable dryer housing casing (34), which encloses a rotationally symmetric drying chamber (36; shown in FIG. 4) extending in the axial direction A′. The dryer further comprises a dryer inlet port (38), which is arranged in an inlet region (40) of the dryer housing (32) and is fluidly connected with the evaporator outlet port (21), for feeding the biomass material discharged from the evaporation chamber (16) into the drying chamber (36). In an outlet region (42) of the dryer housing (32), a dryer outlet port (44; shown in FIG. 4) is arranged, through with the processed material can be discharged from the drying chamber (36).

The evaporator comprises a coaxially extending, drivable evaporator rotor shaft (50), arranged in the evaporation chamber (16), as shown in FIGS. 2 and 3. The evaporator rotor shaft is designed for producing a biomass material film on the internal surface of the evaporator housing casing (14) and comprises a central evaporator rotor shaft body (52) and a plurality of wiping units (54) distributed over the circumference thereof, each wiping unit comprising a plurality of outwardly extending wiping elements (56) arranged successively in axial direction and designed for wiping over the internal surface of the evaporator housing casing. In the specific embodiment shown, the evaporator rotor shaft comprises a number of radial outer rings (58) distributed over the length of the rotor shaft body (52) and arranged coaxially thereto, each being connected to the latter by four webs (60), which are equally distanced over the circumference of the shaft body (i.e. be 90°). To each of the wiping elements shown in FIG. 2, a further wiping element of the corresponding wiping unit is arranged in the axial direction, said further wiping unit being arranged between the one of the radial outer rings shown in FIG. 2 and a further radial outer ring. Thus, a plurality of wiping elements are arranged subsequently to one another one line, all of these wiping elements in one line forming a wiping unit.

The wiping elements (56) of a wiping unit are hinged in a manner such that they are deflectable in relation to the rotation direction of the evaporator rotor shaft (50). Specifically, they are hingedly connected to a support element, more particular in the form of a spindle (62) extending parallel to the axial direction between a first radial outer ring (58a) and a subsequent radial outer ring (58b).

As shown in FIG. 4, the dryer comprises a coaxially extending, drivable dryer rotor shaft (64), arranged in the drying chamber (36), for distributing the biomass material on the internal surface of the dryer housing casing (34) and for conveying the biomass material in the direction away from the inlet region (40) toward the outlet region (42) of the dryer. The dryer rotor shaft (64) comprises a central dryer rotor shaft body (63) and a plurality of rotating elements (66) distributed over the circumference thereof, said rotating elements being rigidly mounted on the dryer rotor shaft body.

As mentioned, both the evaporator housing casing (14) and the dryer housing casing (34) are designed to be heatable. To this end, a housing casing cavity is formed inside the respective housing casing (14; 34), which is intended to be flowed through by a heat carrier medium for heating and/or cooling purposes. In this respect, it is preferred that the wall of the housing casings (14; 34) is of double-walled design and the interspace between housing casing inner wall and housing casing outer wall is intended to be flowed through by the heat carrier medium. For example, a guide spiral for the conductance of the heat carrier medium can be arranged in the cavity, since a very high heating capacity can thereby be obtained.

To set the temperature according to the local requirements in the evaporator (10) or dryer (30), it is further preferred that the respective housing casing (14; 34) comprises at least two housing casing segments, which are designed so as to be heated independently of one another. According to this embodiment, it is further preferred that a separate heat carrier circuit system is assigned to these segments with a separate heat carrier inlet and a separate heat carrier outlet being assigned to each housing casing segment.

In the embodiment shown in FIG. 1, the evaporator housing casing comprises a first, upper casing segment (14a) and a second, lower casing segment (14b), with a first heat carrier inlet (15a) and a first heat carrier outlet (17a) being connected to the first casing segment (14a) and a second heat carrier inlet and a second heat carrier outlet being connected to the second casing segment (14b).

The dryer housing casing of the embodiment shown in FIG. 4 comprises (referring to the direction of conveyance of the material) a first upstream casing segment (34a) and a second downstream casing segment (34b), again with a first heat carrier inlet (35a) and a first heat carrier outlet (37a) being connected to the first casing segment (34a), and a second heat carrier inlet (35b) and a second heat carrier outlet being connected to the second casing segment (34b).

In the dryer shown in FIG. 4, three dryer housing casing segments (34a, 34b, 34c) are shown, with respective heat carrier inlets (35) and heat carrier outlets (37) being connected to the respective casing segment.

The specific dryer shown in FIG. 4 relates to a thin-film dryer in which at least a part of the rotating elements (66) is in the form of a distributing element (661), the radial outer part of which being formed by a distributing blade (68). The distributing blade (68) can run in a direction essentially parallel to the rotor shaft axis, in which case the distributing blade has exclusively a distributing function, meaning that it solely serves to distribute a material film on the internal surface of the housing casing. Alternatively, the edge of the distributing blade (68) can be tilted with regard to the axial direction A′, in which case the respective distributing blade also has a conveying function in addition to the distributing function (thus forming a conveying element 662), meaning that it forces the material in the direction towards the dryer outlet port (44).

A cross-section of an alternative dryer rotor shaft (64′) (designed differently than the one shown in FIG. 4) is shown in FIG. 5.

Specifically, the dryer rotor shaft (64′) of this embodiment comprises segmental discs (65), which are arranged in rows at an angle in the longitudinal direction of the rotor shaft and are designed as leaf-shaped discs having a radial front edge (651) and a radial rear edge (652) in the direction of rotation, the width of which approximately corresponds to the thickness of the discs. The front outer edge is connected to a continuous knife strip (69), the cutting edge of which is aligned in the direction of rotation. The knife strip (69) thus runs along a helical line.

Correspondingly, the segmental scrapers (70) arranged in the circumferential direction between the segmental discs (65) are also arranged angularly offset in a row along the length of the dryer rotor shaft, with a knife strip (72) connecting two scraper arms of the segmental scrapers also being aligned along a helical line which runs parallel to the rotation of the continuous knife strip (69).

The segmental scrapers (70) are preferably offset by 90° to the segmental discs (65) on the dryer rotor shaft (64′).

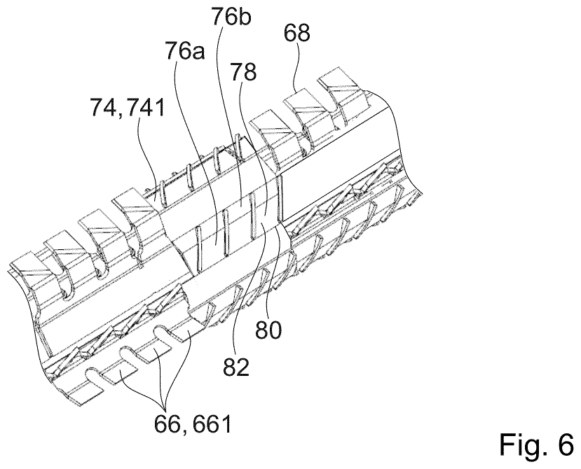

A dryer rotor shaft according to a further embodiment is shown in FIG. 6. This dryer rotor shaft comprises, apart from the rotating elements (66), lift elements arranged on the dryer rotor shaft body (63), which lift elements (74) are designed in such a way as to produce a lifting force in the direction of the dryer rotor shaft (64) body during rotation. In the specific embodiment shown, the lift elements are provided in the form of pitched-roof-shaped web plates (741), the ridge of which runs at least approximately parallel to the axis direction of the dryer rotor shaft.

Due to the angled form, the web plate (741) is thus divided into a first and second web plate surface (76a, 76b), which lie in planes running obliquely relative to one another. The leading first web plate surface (76a) in the rotation direction forms the incident-flow portion (78) of the lift element (74. The leading end (80) of the incident-flow portion (78) in the rotation direction is arranged at a greater distance from the inner surface of the dryer housing casing (34) than a region (82) of the incident-flow portion (78) trailing behind the leading end.

A gap that continuously narrows in a direction counter to the rotation direction is thus formed between the incident-flow portion (78) and the inner surface of the housing casing (34). As the rotor shaft rotates, the biomass material that is to be processed is now pressed into the gap, whereby the flow force of the rotor shaft (64) acting on the incident-flow portion (78) imparts a hydrodynamic lift component perpendicularly to the incident-flow direction and thus counteracts a deflection of the rotor shaft (64).

### LIST OF REFERENCE NUMERALS

10 Evaporator
12 Evaporator Housing
14 Evaporator Housing Casing
14a First, Upper Casing Segment
14b Second, Lower Casing Segment
15a First Heat Carrier Inlet (Evaporator)
15b Second Heat Carrier Inlet (Evaporator)
16 Evaporation Chamber
17a First Heat Carrier Outlet (Evaporator)
17b Second Heat Carrier Outlet (Evaporator)
18 Evaporator Inlet Port
19 Vapour vent
20 Inlet Region of the Evaporator Housing
21 Evaporator Outlet Port
22 Outlet Region of the Evaporator Housing
30 Dryer
32 Dryer Housing
34 Dryer Housing Casing
34a First, Upstream Casing Segment
34b Second, Downstream Casing Segment
34c Further Casing Segment
35 Heat Carrier Inlets
35a First Heat Carrier Inlet (Dryer)
35b Second Heat Carrier Inlet (Dryer)
36 Drying Chamber
37 Heat Carrier Outlets (Dryer)
37a First Heat Carrier Outlet (Dryer)
37b Second Heat Carrier Outlet (Dryer)
38 Dryer Inlet Port
40 Inlet Region of the Dryer Housing
42 Outlet Region of the Dryer Housing
44 Dryer Outlet Port
50 Evaporator Rotor Shaft
52 Evaporator Rotor Shaft Body
54 Wiping Units
56 Wiping Elements
58 Radial Outer Rings
60 Webs
62 Spindle
63 Dryer Rotor Shaft Body
64, 64′ Dryer Rotor Shaft
65 Segmental discs
651 Radial Front Edge
652 Radial Rear Edge
66 Rotating Elements
661 Distributing Element
662 Conveying Element
68 Distributing Blade
69 Knife Strip for Segmental Disc
70 Segmental Scrapers
72 Knife Strip for Segmental Scraper
74 Lift elements
741 Pitched-Roof-Shaped Web Plates
76a First Web Plate Surface
76b Second Web Plate Surface
78 Incident-Flow Portion
80 Leading Edge of Incident-Flow Portion
82 Trailing Region

1. An apparatus for processing a biomass material, which is provided in the form of a mixture comprising a biomass and a processing medium containing or consisting of a distillable nitrogen compound, the apparatus comprising
a) an evaporator comprising
a vertically orientated evaporator housing having a heatable evaporator housing casing, which encloses a rotationally symmetric evaporation chamber extending in the axial direction A,
an evaporator inlet port, which is arranged in an inlet region of the evaporator housing, for feeding the biomass material to be processed into the evaporation chamber,
an evaporator outlet port, which is arranged in an outlet region of the evaporator housing, for discharging the material from the evaporation chamber, and a coaxially extending, drivable evaporator rotor shaft, arranged in the evaporation chamber, for producing a biomass material film on the internal surface of the evaporator housing casing, the evaporator rotor shaft comprising a central evaporator rotor shaft body and a plurality of wiping units distributed over the circumference thereof, each wiping unit comprising a plurality of outwardly extending wiping elements arranged successively in axial direction and designed for wiping over the internal surface of the evaporator housing casing, the wiping elements of a wiping unit being hinged in a manner such that they are deflectable in relation to the rotation direction of the evaporator rotor shaft, and
b) a dryer comprising
a horizontally oriented dryer housing having a heatable dryer housing casing, which encloses a rotationally symmetric drying chamber extending in the axial direction A′,
a dryer inlet port, which is arranged in an inlet region of the dryer housing and is fluidly connected with the evaporator outlet port, for feeding the biomass material discharged from the evaporation chamber into the drying chamber, and
a dryer outlet port, arranged in an outlet region of the dryer housing, for discharging the material from the drying chamber, and
a coaxially extending, drivable dryer rotor shaft, arranged in the drying chamber, for distributing the biomass material on the internal surface of the dryer housing casing and for conveying the biomass material in the direction away from the dryer inlet region toward the dryer outlet region and comprising a central dryer rotor shaft body and a plurality of rotating elements distributed over the circumference thereof, said rotating elements being rigidly mounted on the dryer rotor shaft body.

2. The apparatus according to claim 1, wherein the dryer is a thin-film dryer, in which at least a part of the rotating elements is in the form of a distributing element, the radial outer part of which being formed by a distributing blade.

3. The apparatus according to claim 1, wherein at least a part of the rotating elements of the dryer is in the form of a segmental disc and/or a segmental scraper comprising a peripheral end running parallel to the inner surface of the dryer, the leading edge of the peripheral end being beveled.

4. The apparatus according to claim 1, wherein the biomass material further comprises water.

5. The apparatus according to claim 1, wherein it comprises a vapour vent for removing vapour generated during processing from the evaporation chamber and the drying chamber, respectively.

6. The apparatus according to claim 5, wherein the vapour vent is fluidly connected to a column for condensing water contained in the vapour and a channel for re-introducing at least a part of the condensed water back to the drying chamber.

7. The apparatus according to claim 1, wherein the wiping elements of a wiping unit are hingedly connected to a support mounted to the evaporator rotor shaft.

8. The apparatus according to claim 1, wherein at least a part of the rotating elements form, at least in their peripheral region facing the inner surface of the dryer housing casing, an angle of inclination in relation to axial direction A′.

9. The apparatus according to claim 1, wherein the dryer rotor shaft comprises at least one lift element arranged on the dryer rotor shaft body, which lift element is designed in such a way as to produce a lifting force in the direction of the rotor shaft body during the rotation of the rotor shaft.

10. The apparatus according to claim 9, wherein the lift element has a planar incident-flow portion with a leading end in the rotation direction, which leading end is arranged at a greater distance from the inner surface of the dryer housing casing than a region of the incident-flow portion trailing behind the leading end, whereby a gap that narrows in a direction opposite the rotation direction is formed between the incident-flow portion and the inner surface of the dryer housing, in particular a continuously narrowing gap.

11. A method for processing a biomass material using an apparatus according to claim 1, the biomass material being provided in the form of a mixture comprising a biomass and a processing medium containing or consisting of a distillable nitrogen compound, wherein said method comprises the subsequent steps of:
i) feeding the biomass material into the evaporator for pre-concentrating the biomass material by partially evaporating the processing medium, and
ii) transferring the biomass material pre-concentrated in step i) into the dryer for further evaporating residual processing medium.

12. The method according to claim 11, wherein the biomass material fed into the evaporator in step i) further comprises water.

13. The method according to claim 11, comprising the further steps of collecting and condensing the evaporated processing medium.

14. The method according to claim 11, wherein water removed by evaporation in step i) and/or step ii) is at least partially re-introduced into the drying chamber.

15. The method according to claim 11, wherein the processing medium contains a nitrogen-containing distillable acid-base conjugate salt (DABCS) or deep eutectic solvent (DES), in which
the DABCS is a protic ionic liquid (PIL) or a protic salt comprising a DABCS cation and a DABCS anion, and
the DES is any combination of Lewis or Bronsted acid and base comprising any anionic and/or cationic species that have sufficient vapor pressure so that it can be readily distilled.

16. The method according to claim 11, wherein both in the evaporator and in the dryer the operating pressure is in the range of from 10⁻² mbar to 10³ mbar, preferably in the range of from 10 mbar to 500 mbar, more preferably in the range of from 50 to 250 mbar.

17. The method according to claim 11, wherein both in the evaporator and in the dryer the internal surface of the evaporator housing casing and the dryer housing casing, respectively, is heated to a temperature in the range of from 20° C. to 200° C., preferably of from 50° C. to 170° C., more preferably of from 80° C. to 160° C., and most preferably from 100° C. to 140° C.

18. The method according to claim 11, wherein the biomass material to be processed has an initial shear viscosity of from 10 to 50,000 mPa*s, preferably in the range of from 100 to 20,000 mPa*s, more preferably about 500 to 15,000 mPa*s.

19. The method according to claim 11, wherein the biomass material to be processed has an initial content of processing medium in the range of from 15 to 95 wt. % referring to the total amount of the biomass material, preferably from 20 to 90 wt. %, more preferably from 30 to 70 wt. %, most preferably from 40 to 50 wt. %.
